(19) United States
(12) Patent Application Publication
(10) Pub. No.: US 2002/0166251 A1
(43) Pub. Date: Nov. 14, 2002

(54) THRU THE BAR BORE MEASURING TOOL

(76) Inventor: JAMES A. JONES, FT. LUPTON, CO (US)

Correspondence Address: JAMES A JONES, 855 S FULTON AVENUE, FT. LUPTON, CO, 80621

(21) Appl. No.: 09/473,733

(22) Filed: Dec. 28, 1999

(51) Int. Cl. G01B 5/00

(52) U.S. Cl. 33/542

(57) ABSTRACT

The measuring tool assembly consists of a Body (10) which contains a Spring (13), Spring Rod (11), Locking Screw (12) and Threaded Extension (14). The Shape of the Body (10) is designed specifically to fit into standard cutting tool mounting holes on a variety of devices which can machine or re-machine bored holes. The Threaded Extension (14) is opposite and directly opposes the Spring Rod (11). When inserted into a Bore (16) to be measured, the Spring Rod (11) is forced outward from the Body (10) by the force of the Spring (13) until it comes in contact with the Bore wall (16), the Body (10) then slides in the cutting tool hole (17) until the Threaded Extension (14) comes into contact with the opposite Bore wall (16). The Locking Screw (12) is then tightened and the distance from the end of the Spring Rod (11) and the Threaded Extension (14) can be measured to determine the diameter of the Bore (16). A infinite number of variable Spring Rod (11) and Threaded Extension lengths can be used to measure any size bored hole.

### BACKGROUND—Field of Invention

The measuring tool of this invention is used to measure the exact distance across the inside diameter of a bore or hollow cylinder while an object, such as a boring bar or other inside diameter cutting or machining device is extended into the bore or cylinder which would normally interfere with measuring devices that require the inside of the bore or cylinder be completely clear of any restriction or obstacles.

In shop and field applications such as those related to portable line boring of pin and bushing bores on mining and construction equipment, the exact measurement of the inside diameter of the bore or cylinder in most all cases must be made while the bore machining device, portable boring bar, is extended through the center of the bore or bores.

The removal of the boring bar to make an exact measurement of the bore inside diameter increases the time and cost to machine the bore and also increases the possibility of over machining the bore, thus making it too large for the design purpose. Therefore, a measuring tool that does not require the removal of the boring bar and offers a mechanical contact with surfaces across the inside diameter of a bore of cylinder greatly reduces the cost of taking such measurements and reduces the possibility of over machining the bore. Typically these measurements are made using hand held adjustable inside spring calipers which are extended into the end of the bore and around the boring bar for inside diameter measurements or extend from the boring bar surface to the bore surface on the radius. Both of these type measurements require an experience factor for the operator and in most cases multiple measurements are required for accuracy.

The measuring tool of this invention requires that a hole just large enough to fit a tool body of at least ⅜ inch diameter or ⅜″ inch square tool hole, usually a square broached hole, be drilled or cut through the centerline diameter of the boring bar.

The measuring tool can then be inserted through the hole in the boring bar, then extended into the bore or cylinder when the portable boring bar is inserted into the inside diameter of the bore or cylinder.

The spring loaded rod then forces the threaded extension toward the opposite side of the bore which established the exact inside diameter of the bore or cylinder. The ability of the operator to take measurements across the centerline diameter, without having to disassemble all or part of the bore machining set-up and equipment greatly reduces the time and cost of the operation, as well as the accuracy of the measurement.

### BACKGROUND—Description of Prior Art

In machining operations the inside diameter of machined bores or holes can be measured in a variety of ways with standard inspection tools. One such method of machining holes is accomplished with a device known as a boring bar.

Heretofore many devices have been devised for the accurate measuring of such bored holes. Each requires, however, the removal of the mechanism or device, which actually machines the bore, from the bore before a measurement can be taken.

One such device, shown in U.S. Pat. No. 919,455 assigned to Pietsch (1909), shows a micrometer gage with an adjustable rod at one end and a spring loaded rod at the opposite end. The spring rod has a blade attached to it which registers against a scale on the fixed body of the micrometer. The device is used by setting the distance from the end of the fixed rod to the end of the fully extended spring loaded rod, exactly to the distance desired for the bore. The spring loaded rod can be compressed so that the tool can be inserted into an inside diameter and as the spring extends the spring loaded rod outward, the exact diameter can be verified by the scale and blade arrangement. A disadvantage of this design is that the micrometer requires removal of the cutting tool from the bore prior to the micrometer being inserted into the bore. Another disadvantage is that if the bore diameter was made larger than the “target” diameter set on the micrometer gage, the gage would not be able to detect this condition, as the spring rod bottoms out at the “target” diameter. Another disadvantage is that the micrometer gage cannot be inserted too deep into a bore as the scale and blade arrangement would be difficult to read. An example of this condition would be a bore with a counter bore lead in.

Heydrich, in U.S. Pat. No. 339,410 (1886), shows an adjustable interior caliper with a fixed pin at one end and a screw adjustable pin at the opposite end. The fixed pin can be adjusted in and out of the caliper tube for different diameters by loosening a set screw, adjusting the position of the pin to the desired length and re-tightening the set screw. The caliper is then inserted into the bore and the screw adjustable pin is adjusted outward until both pins make contact with the opposite sides of the bore walls. A disadvantage of this design is that the caliper requires removal of the cutting tool from the bore prior to the caliper being inserted into the bore. Another disadvantage is that once inserted into the bore, the adjustable pin has to be manually actuated outward to make contact with bore wall which can be problematic on deeper bores.

See also generally, Wold, U.S. Pat. No. 746,622, Parker, U.S. Pat. No. 1,436,355, Graham, U.S. Pat. No. 2,287,097, Lee, U.S. Pat. No. 2,470,254, Broden, U.S. Pat. No. 2,730,810, Fredd, U.S. Pat. No. 2,818,654, Schaerer, U.S. Pat. No. 2,847,764, Kinley, U.S. Pat. No. 2,853,788, Broden, U.S. Pat. No. 2,912,765, Frei, U.S. Pat. No. 3,354,552, Okazaki, U.S. Pat. No. 3,781,998, von Voros, U.S. Pat. No. 4,008,523, Hutter et al., U.S. Pat. No. 4,028,811, Fadl et al., U.S. Pat. No. 4,030,202, Yamauchi et al., U.S. Pat. No. 4,136,456, Nanstiel, Jr., U.S. Pat. No. 4,253,241, Meyer, U.S. Pat. No. 4,265,026, Arsenault, U.S. Pat. No. 4,611,404, Hitt, U.S. Pat. No. 4,623,286, Sattman, U.S. Pat. No. 4,843,722, Fendler, U.S. Pat. No. 4,861,202, Lavin et al., U.S. Pat. No. 5,025,996, Lavin et al., U.S. Pat. No. 5,123,601, Rank, U.S. Pat. No. 5,421,101.

### Objects and Advantages

Accordingly, several objects and advantages of my invention are to provide an easy to use and time saving method to precise measuring of the inside diameters of bored and machined holes, which is without the requirement of other measuring devices that require the removal of the boring or machining device from the hole, which is designed to fit into standard and non standard boring or machining devices with a wide variety of geometries and which is easily adjustable for a wide variety of hole sizes.

Still further objects and advantages will become apparent from a consideration of the ensuing description and accompanying drawings.

### BRIEF DESCRIPTION OF THE DRAWINGS

FIG. 1 is a full side view cross section showing the five components of the measuring tool. An end view, if shown, could show the tool body (10) as square, round or multi sided (such as a hexagon) where as all other components are round.

FIG. 2 shows a cross section of a bore or cylinder area with the boring bar through the bore or cylinder. The bore measuring tool is inserted through a hole in the boring bar, extended into the bore area and expanded by the force of the spring rod to make contact with the inside diameter of the bore surface.

FIG. 3 shows the normal setup and the components required to do machining operations with a portable boring bar. This is one of many possible examples of the use of this invention. Other applications include, but are not limited to, lathes, milling machines, horizontal and vertical boring mills as well as others. FIG. 3A Isometric depiction of FIG. 3 Ref. 1A shows telescoping gages and spring dividers or calipers typically used for measuring distances from surface to surface.

Ref. 4A shows an example of outside micrometers and dial calipers used for making precise measurements between two surfaces.

### REFERENCE NUMERALS

10 Body

11 Spring Rod

12 Locking Screw

13 Spring

14 Threaded Extension

15 Boring Bar

16 Bore or Cylinder

17 tool hole

18 Bearings

19 Bar Drive

20 Feed Control

21 Cutting Tool

### SUMMARY

A internal bore diameter measuring tool comprising: a Body member of specific geometry which has at one end a tapped hole or similar feature which houses a Threaded Extension, a bored hole at the opposite end which houses a Spring and Spring Rod and a tapped hole or similar feature which is perpendicular to the bore for the Spring and Spring Rod which houses a Locking Screw or similar locking device, a Threaded Extension with male threads or similar attachment feature at one end and a larger post diameter extending from the threaded portion a fixed length which makes contact with one wall of the bore or cylinder, a Spring which is inserted into the bore in the Body member and which provides a linear force against the Spring Rod, a Spring Rod inserted into the bore in the Body member and on top of the Spring which makes contact with the opposite wall of the bore or cylinder, a Locking Screw or similar locking feature which is inserted into the tapped hole in the

Body Member which is perpendicular to the bore for the Spring and Spring Rod and locks the Spring Rod into place.

### PREFERRED EMBODIMENT—Description

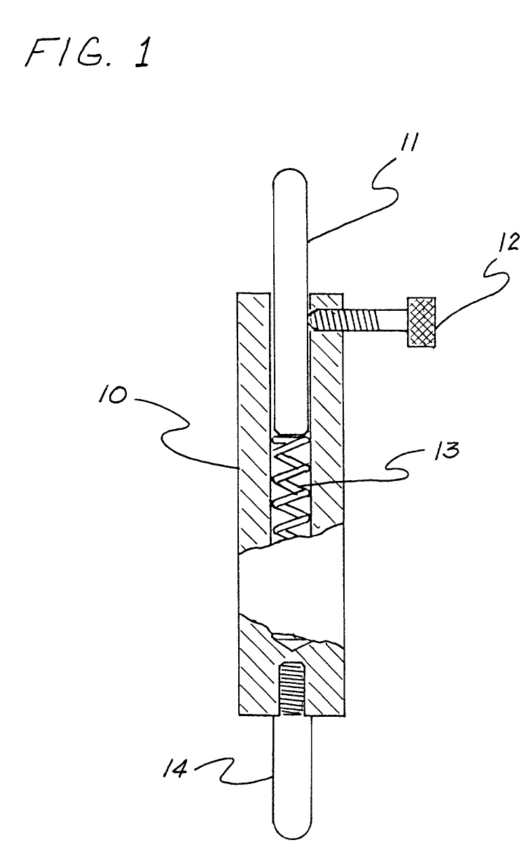

FIG. 1 shows the components of the bore measuring tool which are the Body 10, the Threaded Extension 14, the Spring Rod 11, the Spring 13 and the Locking Screw 12.

The Body 10, which can be made from metal or plastic material in a round, square or multi sided shape. The body can be manufactured from stock material when the stock dimensions are within tolerance requirements, or the body dimensions can be machined to size. The Body 10, has a drilled and tapped hole in one end to receive the male thread of the Threaded Extension 14. The Threaded Extension 14 can be fabricated in different lengths or can be made in a series of screw together pieces to extend to different lengths. The ends of Threaded Extension 14 and Spring Rod 11 can be rounded to allow them to slide on the I.D. surface of the bore being measured.

The opposite end of Body 10 is bored to a sufficient depth to accept the Spring 13 and a portion of the Spring Rod 11. The Spring Rod 11 can be made in different lengths or made of screw together pieces to extend to different lengths. Also on this end of the Body 10, a hole is drilled and tapped at a right angle to the bored hole for the Spring 13 and Spring Rod 11 so that the Lock Screw 12 can be used to lock the Spring Rod 11 in any extended position, once the Spring 13 has forced the Spring Rod 11 against the surface of a Bore 16 or Cylinder 16.

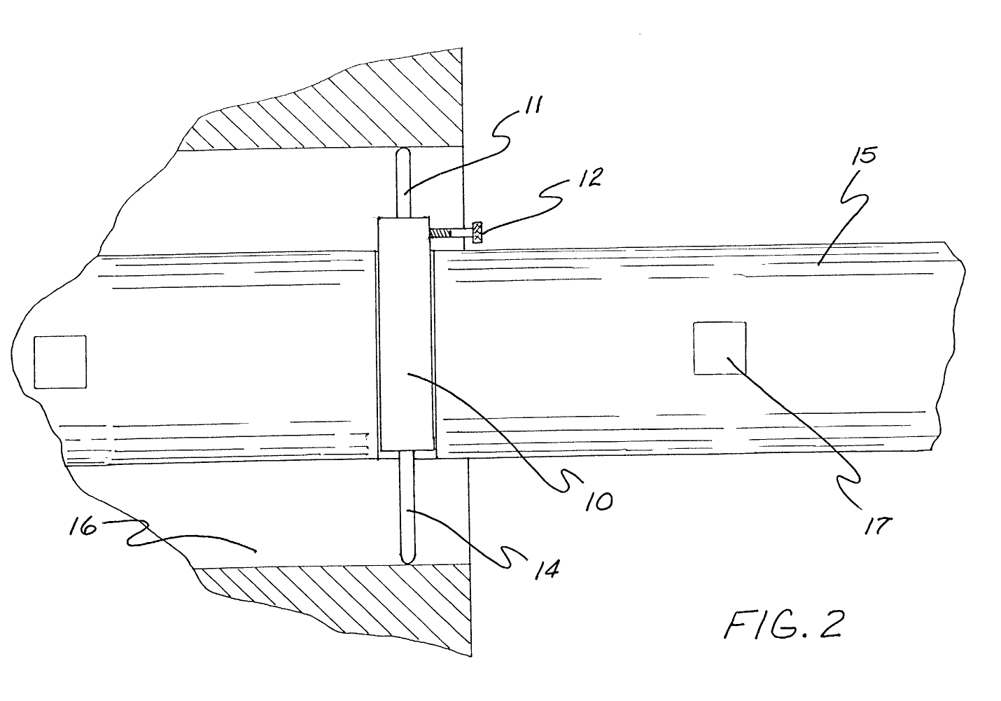

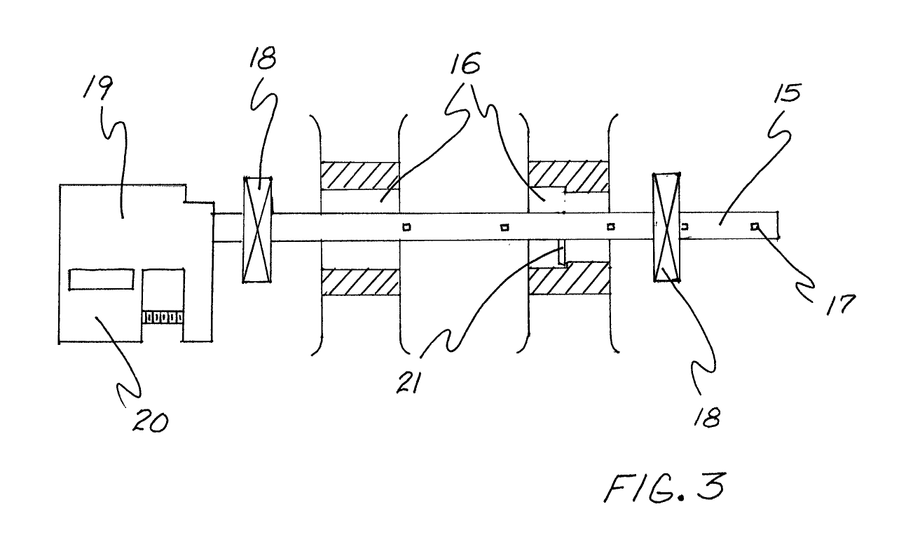

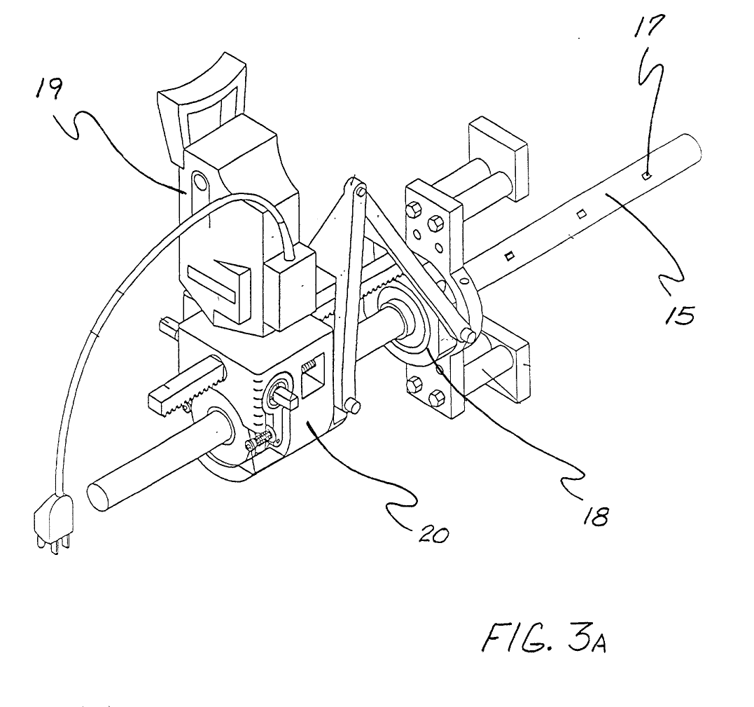

FIG. 2 shows the actual function of the measuring tool of this invention. FIG. 2 shows the Bore 16 or Cylinder 16 that is to be measured. The Boring Bar 15 will have a series of cutting tool holes 17 at various distances along its length. These tool holes 17 can be round or square broached holes through the Boring Bar 15. FIG. 2 also shows the measuring tool assembly 10, 11, 12, 13 and 14 across the Bore 16.

The Boring Bar 15 and the measuring tool assembly 10, 11, 12, 13 and 14 are then retracted from the Bore 16, and the measuring tool assembly 10, 11, 12, 13, and 14 is removed from the tool hole 17 in the Boring Bar 15.

A standard outside micrometer or caliper is then used to measure the distance from the tip of the Threaded Extension 14 to the tip of the Spring Rod 11 to establish the diameter of the Bore 16. See reference 4A.

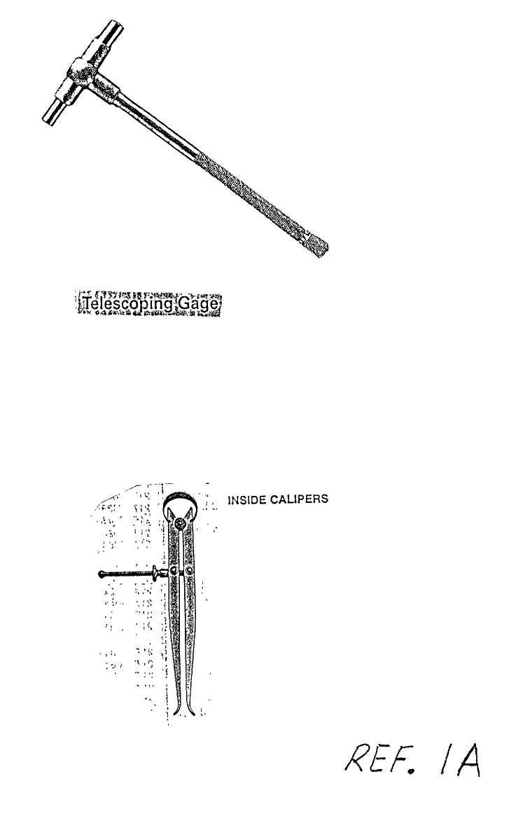

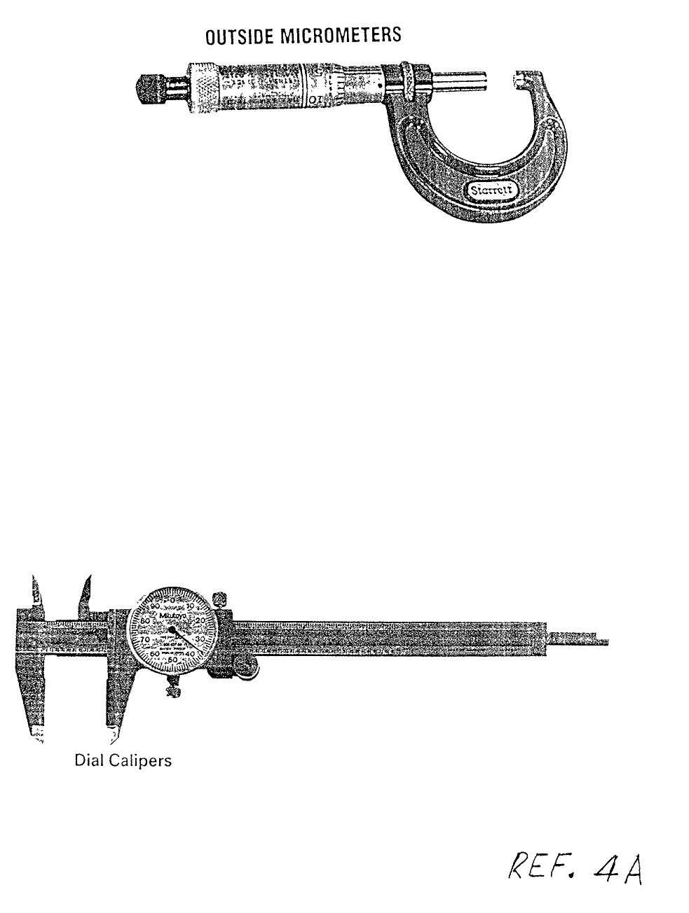

FIG. 3 shows the typical components in the set-up of a portable Boring Bar 15 which is the most common use of the measuring tool assembly 10, 11, 12, 13 and 14.

These components and their function include the Bar Drive 19 which can be hydraulic, electric, pneumatic or manually powered. The Feed Control 20 which can be hydraulic, electric, pneumatic or manually powered, controls the feed rate of the Boring Bar 15 and thus the Cutting Tool 21 into the Bore 16 being machined.

The Bar Drive 19 rotates the Boring Bar 15 at various rotational speeds and the feed control advances the Boring Bar 15 into the Bore 16, usually in thousandths of an inch per revolution.

The Boring Bar 15 is supported on the centerline of the Bore 16 or multiple in line Bores 16 by Bearings 18. These Bearings 18 are mounted on the part being machined by a weldment or bracket which will be based on operator technique on each application of a portable Boring Bar system.

A Cutting Tool 21, typically tool steel or brazed carbide, is inserted into the Boring Bar 15 through a Cutting Tool hole 17 and locked into position with a set screw. The Bar Drive 19, then provides the rotation, the Feed Control provides the advance, thus producing a machine cut for re-sizing of the Bore 16.

Upon completion of this cutting or re-sizing of the Bore 16, the measuring tool assembly 10, 11, 12, 13 and 14 can again be inserted into the Boring Bar 15 and a new measurement can be established following all of the steps previously described in this embodiment.

### Preferred Embodiment—Operation

Operation and use of the Thru The Bar Measuring Tool of this invention is straightforward and easy to use for those skilled in the art. Once a boring or machining operation has been performed on the Bore 16, by a portable boring bar or similar device, the Boring Bar 15 is pulled out of the bore far enough to expose the cutting tool hole 17. The measuring tool assembly 10, 11, 12, 13 and 14 is then inserted into the cutting tool hole 17. The Boring Bar 15 is then moved back into the Bore 16 such that the measuring tool assembly 10, 11, 12, 13 and 14 is now inside the Bore 16. Insertion of the measuring tool assembly 10, 11, 12, 13 and 14 can be facilitated by compressing the Spring Rod 11 down into the Body 10 as it is entering the Bore 16. The Spring Rod 11 is then released and the force of the Spring 13 forces the Spring Rod 11 and the Threaded Extension 14 to make contact with opposite sides of the Bore 16. The operator then tightens the Lock Screw 12 against the Spring Rod 11 thus setting the tool to the exact diameter of the Bore 16. The Boring Bar 15 can then be pulled out of the Bore 16 far enough to expose the measuring tool assembly 10, 11, 12, 13 and 14. The distance across the Threaded Extension 14 and the Spring Rod 11 can then be measured using calipers, outside micrometers or a similar commercially available measuring tool.

### CONCLUSIONS, RAMIFICATIONS, AND SCOPE

Accordingly, it can be seen that the Measuring Tool of this invention includes a body to house a spring forced rod and a threaded extension suitable in length to contact opposite sides, on the inside diameter, of a bore or cylinder. The threaded extension suitable in length to touch one side of the bore or cylinder and the spring forced rod suitable in length to touch the opposite side of the bore or cylinder form a fixed distance on the inside diameter of the bore or cylinder. As stated, this arrangement has the distinct advantage of not having to remove the cutting or machining mechanism from the bore or cylinder in order to accurately measure the bore inside diameter. A primary use of this tool would be in conjunction with machine tools known in the industry as portable line boring equipment.

Although the description above contains many specificities, these should not be construed as limiting the scope of the invention but as merely providing illustrations of some of the presently preferred embodiments of this invention. Various other embodiments and ramifications are possible within its scope. For example, this tool can also be used with many standard machining methods such as Lathes, Horizontal Milling Machines, Vertical Milling Machines, Drill Presses as well as many other methods.

Thus the scope of the invention should be determined by the appended claims and their legal equivalents, rather than by the examples given:

What is claimed is:

1. A measuring tool arrangement comprising:
a Body member,
a Threaded Extension which is attached to said Body member by threads or similar means,
a Spring which is inserted into a bored hole in said Body member which directly opposes said Threaded Extension,
a Spring Rod which is inserted into said bored hole in said Body member on top of said Spring, all of which directly opposes said Threaded Extension,
a Locking Screw that threads into a tapped hole in said Body which is perpendicular to said Spring Rod and extends through to said bored hole in said Body for said Spring Rod, wherein the said Locking Screw is tensioned against the said Spring Rod.

2. An apparatus, as claimed in claim 1, wherein:
said Body Member can be designed in a wide variety of geometries, such that the apparatus can be adapted to any shape cutting tool hole or other hole or feature in the mechanism performing the machining, cutting or boring operation.

3. An apparatus, as claimed in claim 1, wherein:
said Locking Screw takes the form of an electrically or pneumatically operated plunger that can be actuated from an external switch or valve to lock the said Spring Rod in position.

4. An apparatus, as claimed in claim 1, wherein:
said Spring and said Spring Rod take the form of a linear variable differential transducer (LVDT) such that the diameter reading of the bore being measured can be taken immediately and without other measuring devices, by utilizing said LVDT in conjunction with an operator interface or electronic display.

5. An apparatus, as claimed in claim 1, wherein:
said Spring and said Spring Rod take the form of any number of electronic or mechanical distance measuring devices such that the diameter reading of the bore being measured can be taken immediately and without other measuring devices, by utilizing said electronic or mechanical distance measuring devices in conjunction with an operator interface or electronic display.
